(19) United States
(12) Patent Application Publication
(10) Pub. No.: US 2024/0346638 A1
(43) Pub. Date: Oct. 17, 2024

(54) SYSTEMS AND METHODS UTILIZING ARTIFICIAL INTELLIGENCE FOR AUTOMATED VISUAL INSPECTION OF ROPES

(71) Applicant: Samson Rope Technologies Inc., Ferndale, WA (US)

(72) Inventors: James R. PLAIA, Blaine, WA (US); Chad HISLOP, Redmond, WA (US); Dean HAVERSTRAW, Bellingham, WA (US); Garth TODD, Kirkland, WA (US)

(21) Appl. No.: 18/625,660

(22) Filed: Apr. 3, 2024

Related U.S. Application Data
(60) Provisional application No. 63/495,562, filed on Apr. 12, 2023.

(51) Int. Cl. G06T 7/00; G06N 20/00; G06T 7/194

(52) U.S. Cl. CPC G06T 7/0002; G06N 20/00; G06T 7/194; G06T 2207/20021; G06T 2207/20081; G06T 2207/20132

(57) ABSTRACT

A computer-implemented method using a mobile device to inspect a rope. Visual data is captured, wherein the visual data includes one or more sections of the rope along a length thereof. The images are analyzed using a knowledge base implemented within logic of a control system of the mobile device. From the knowledge base, an expected life for the rope is calculated, and a report is generated on the mobile device to display the expected life of the rope as calculated from the knowledge base. The method further includes the step of processing the visual data to ready the visual data for analysis. This involves breaking down the visual data into tiles, wherein the visual data is broken into multiple image segments along the length of the rope.

### CROSS REFERENCE TO RELATED APPLICATIONS

The present application claims benefit of provisional application Ser. No. 63/495,562, filed Apr. 12, 2023, the contents of which are incorporated herein by reference.

### BACKGROUND

Quantitative non-destructive evaluation (NDE) of rope refers to the evaluation of rope characteristics indicative of ability of rope to serve a predefined function. In most prior art NDE systems, while the end-result calculations account for multiple forms of data across multiple sub-components of the rope, the testing parameters are pre-determined. For instance, the data is multi-sourced, but consists, in part, of rope construction type, rope characteristics, adjustment factors, and interaction characteristics. Such data points result in a calculation that is a numerical definition of rope life, but such data points are finite. In other words, the calculations would be based on expected parameters that are pre-programmed into a database. In fact, if the total adjusted remaining life of the rope under test does not meet “predetermined parameters”, some of the data would have to be modified or removed in order to provide an accurate, or meaningful response.

Additionally, while some visual guides are available for comparing rope to one of a finite number of pre-determined conditions, the use of such guides is largely dependent on user skill. Moreover, even experienced human observation might be insufficient to perceive certain visual cues and/or to assess where a rope falls between two finite conditions that could meaningfully impact the estimated remaining service life of a rope.

Further, systems which attempt to capture multiple data points along a rope utilize large, in situ scanners and winches. Such devices are not portable and might be located where the rope to be examined is not. Other drawbacks in systems utilizing multiple datapoints and for which such data is captured with other than a portable, mobile device is that in instances where the inspection of the rope occurs at a remote location, such as on ships at sea, network connectivity is an issue.

Lastly, along a rope, there may be sections which share different types and degrees of damage. For example, alongside very subtle UV damage there may be a significant tear. Without refinement, a system might ignore the UV damage in favor of the more visible tear, especially due to their proximity. Any system must account for these subtleties and not merely bypass lesser components or extents of damages in favor of the greater degree, as follows.

In the instant system and method, using a mobile device, visual data is captured and analyzed using a trainable knowledge base, i.e. artificial intelligence, to report the similar quantitative measure of rope life, i.e. rope health, but using this different qualitative approach within its control system, as follows.

### SUMMARY

It is an objective of the present invention to provide a rope health risk analysis system or method which reports a measurement derived from a visual examination, or visual inspection (“VI”) of the rope.

It is further an objective to allow for the visual inspection using a mobile device which is physically moved along the length of the rope while the rope is stationary, or during rope deployment, in part so that the inputs and outputs can be generated efficiently, quickly and from remote locations independent of any fixed, scanning system.

It is further an objective to more accurately account for minor variations in rope strand damages which are in proximity to one another so as not to bypass a lesser, although quantifiable calculation.

It is further an objective to provide and use artificial intelligence and a trainable knowledge base that learns the patterns and relationships of the images to continuously and iteratively adjust its outputs.

Accordingly, comprehended is a computer-implemented method comprising: using a mobile device, capturing visual data of a rope, wherein the visual data includes one or more sections of the rope along a length thereof; analyzing the visual data using a knowledge base implemented within logic of a control system of the mobile device; calculating, from the knowledge base, an expected life for the rope; generating a report on the mobile device and displaying the expected life of the rope as calculated from the knowledge base. The method further includes the step of processing the visual data to ready the visual data for analysis. This image processing step involves breaking down the visual data into tiles, wherein the visual data is broken into multiple image segments along the length of the rope. The knowledge base is continuously supplemented and trained using a data pipeline, and the knowledge base continuously learns to enhance calculations for the expected life. Of further note is that for the step of capturing the visual data, the mobile device is moved along the rope.

Also comprehended is the non-transitory computer-readable medium with stored instructions that cause one or more processors to perform the same steps of: using a mobile device, capturing visual data of a rope, wherein the visual data includes one or more sections of the rope along a length thereof; analyzing the visual data using a knowledge base implemented within logic of a control system of the mobile device; calculating, from the knowledge base, an expected life for the rope; generating a report on the mobile device and displaying the expected life of the rope as calculated from the knowledge base.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 schematically depicts an example rope section under visual inspection.

FIG. 2 shows an example graphical user interface of the instant visual inspection (VI) system.

FIG. 3 is a block diagram representing the VI system hardware of the present invention.

FIG. 4 schematically shows the functionality and benefits of the VI system.

FIGS. 5 and 6 show how the knowledge base of the VI system is built using an example image set with the image processing, i.e., tiling module applied.

FIG. 7 is a block diagram showing the process flow for the image processing creating the final images used by the knowledge base for both training and assessment.

Wherever possible, the same reference numbers will be used throughout the drawings to represent the same parts.

### DETAILED DESCRIPTION OF THE INVENTION

U.S. Pub. 2021/0190756 (′756) is incorporated herein by reference in its entirety.

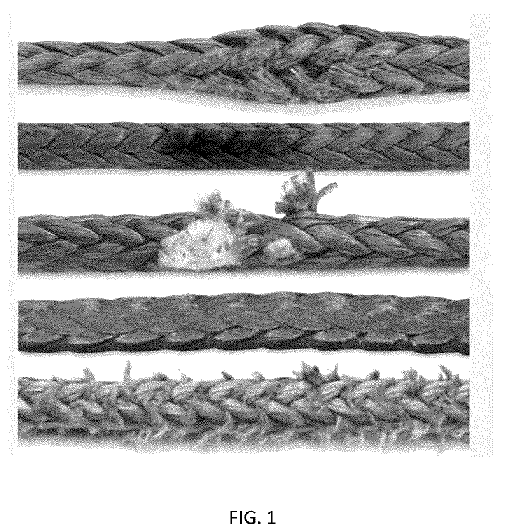

Relevant here are the similar definitions of rope characteristics that are observable and contribute to rope life, i.e. rope health. With reference to FIG. 1, for example only, and as cited therein, UV damage, for instance, is a damage mode that might have visual cues but assessment of which typically produces a quantitative result that can be directly related to changes in rope strength. The number of cut strands in a rope is an example of a quantitative result which must then be related to rope risk through some correlation. Finally, an example of a qualitative measurement is the categorization of external or internal abrasion severity which can be empirically correlated to a risk level. FIG. 1 is an image capture showing various internal abrasions, tears and burns along a section (i.e., portion of the rope), thus a visual data or visual cue of damage retrieved from the image capture.

The example rope under test comprises a plurality of rope sub-components or sections each comprising a plurality of rope fibers. While only one type of rope sub-component is shown in FIG. 1, a particular type of rope can and typically will comprise more than one type of rope sub-component. For example, the rope fibers are typically grouped in a first rope sub-component referred to as yarns, and the yarns are typically grouped in a second rope sub-component referred to as strands. In that case, the yarns are combined to form multiple strands and multiple strands are combined to form the rope. In addition, a particular rope may include fibers of different compositions, yarns of different sizes and compositions, and/or strands of different sizes and compositions. Further, the strands may be combined using any one or more techniques such as twisting and braiding, and the rope itself may comprise major components such as a core and a jacket. The example rope under test thus is intended to generically represent ropes of different fiber compositions, yarn structures, strand structures, and rope structures and across various sections along the length (or width) of the rope.

In the prior art, the overall risk analysis systems and methods take into account the fact that many of these modes have synergistic or antagonistic effects when forced to interact with each other due to proximity in the rope. However, such modes are not only finite data points but on occasion would not be collectable from visual data. Prior art further refinement permits inclusion of information derived from sources beyond the rope condition assessment. These information sources could include a time history of the tension applied to the rope during its use history, a count of bend cycles sections the rope experienced, or even information that could be used to infer the rope history, such as the weather in the locations where the rope was used for mooring ropes because the weather conditions and mooring port locations affect the tensions and temperatures the rope experiences. Again, however, such data is traditionally inputted from non-visual cues, in contrast to the present technology.

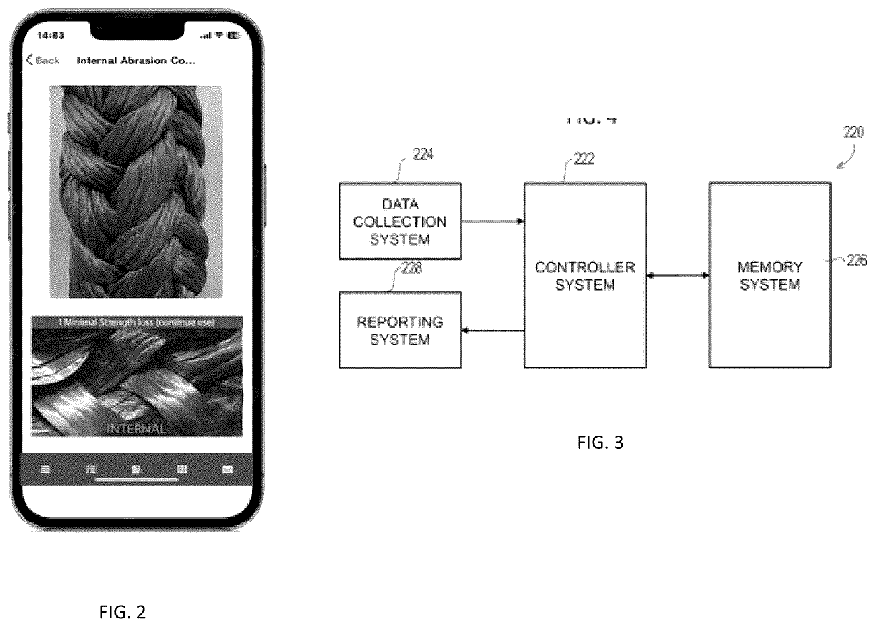

To address these complexities, with continued reference to FIGS. 1-5, particularly FIG. 2, a rope health risk analysis system or method of the present invention consists of a visual examination, or visual inspection (“VI”), hence a VI system. Using a mobile device, the visual data is collected indicative of rope characteristics of a rope, including capturing visual data of the rope. “Visual data” means any form of data that is in a visual format including, but not limited to, images, videos, computer-generated imagery, models and graphics. To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well. In addition, a computer can interact with a user by sending documents to and receiving documents from a device that is used by the user; for example, by sending web pages to a web browser on a user's client device in response to requests received from the web browser. FIG. 2 is an example of visual data shown by the graphical user interface of the instant VI system.

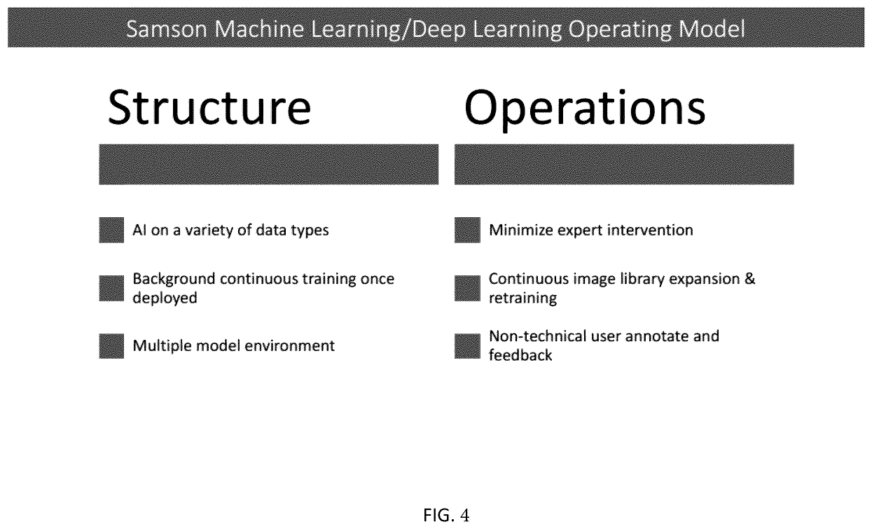

With particular reference now to FIGS. 3-4, the visual data is analyzed using a trainable knowledge base implemented within logic of a control system of the mobile device processor. The trainable knowledge base first includes the visual data (see FIG. 1) known from prior captures which forms part of the initial data pipeline. The trainable knowledge base thereafter is trained by providing it with a large amount of continued, relevant visual, capture data. In turn, the knowledge base learns the patterns and relationships of the images to continuously and iteratively adjust its outputs. The knowledge base building and training is further elaborated upon in the aforementioned examples. From the knowledge base, an expected life for the rope is then calculated as the output, thereby displaying a report on the mobile device indicative of the expected life of the rope. Being on a mobile device, the inputs and outputs can be generated quickly and from remote locations.

Using the knowledge base, the resulting virtual rope is analyzed to arrive at a similar estimated risk of failure of the rope but using largely only visual cues, made possible by the intelligent database. In the same way, the resulting risk analysis can be used as a snapshot of the current condition and/or in conjunction with previous risk analyses prepared from earlier evaluations of the rope condition to understand the trend and the degree and nature of damage that a given rope use application might subject the rope to.

Here, embodiments and the operations shown in the drawings and described in this specification are computer-implemented systems and methods. This means it can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including, by way of example, a programmable processor, a computer, a system on a chip, or multiple ones, or combinations, of the foregoing. The apparatus can include special purpose logic circuitry, for example, a central processing unit (CPU), a parallel graphics processing unit (GPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example, an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

FIG. 3 illustrates the hardware layout of the embodied VI system 220 of the present invention. Here, the controller system 222 is the client mobile device collecting visual data from a data collection system 224, which then stores the data in a memory system 226, and generates reports on a reporting system 228. The report may take any form including a number of hours, e.g., 1200 hours, or days, months or years correlating to the expected life of the rope along with (or without) verbiage supplementing, explaining or qualifying the report including ranges and/or non-numerical determinations of the effect of multiple rope damage types, especially in cases where such quantification may be difficult. The controller system 222, data collection system 224, memory system 226, and reporting system 228 may all be embodied as an app running on one or more general purpose portable computing device, such as a smartphone, tablet computer, or laptop computer or may take the form of a distributed computing system implemented by a number of separate devices, at least a portion of which is accessible over the internet (e.g., cloud-based computing). It should be known, a computer program is an executable program of instructions which can be executed on one computer or on multiple computers that are located at one site or distributed across multiple sites and interconnected by a communication network. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry. Additionally, processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment.

Embodiments can be implemented using the computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with or through a server. In the preferred embodiment herein, the client is a mobile device which carries out the process, which can be done at a remote location, such as on a sea-going vessel. The mobile device/client is then brought back to the physical shore location and the data can be uploaded onto a server for processing when the communication network is more accessible.

Now, the data collection system 224 here is embodied as one, two, or more mobile computing devices capable of allowing a user to obtain, record, or input data (e.g., numerical, visual, sound, spectral, chemical, etc.) indicative of rope characteristics processed by the example VI system 220 through its acquisition, or capture, of visual data. Further, this data can be collected continuously, asynchronously, periodically, or according to a predetermined schedule by one or many computing devices over the life of the rope under test. The data collection system 224 may also take the form of a sensor system customized to collect and report, continuously, asynchronously, periodically, or according to a predetermined schedule, data such as weather conditions (e.g., thermometer, barometer), locations (e.g., GPS tracker), and use conditions (e.g., tension loads) of a specific rope under test. Such data can also be used to determine rope characteristics that may be considered by the example VI system 220 when determining remaining life of a particular rope.

The example memory system 226 will typically take the form of a database capable of persistently storing data indicative of calculations of remaining life for a plurality of ropes under test. The database forming the memory system 226 will typically be configured to store data identifying and associated with many specific ropes in use at different locations. Typically, but not necessarily, the database forming the memory system 226 is configured to store, in addition to remaining life, all raw data associated with specific tests (e.g., locations, ambient conditions, rope characteristics, etc.) conducted at specific points in time for each specific rope tracked by the database forming memory system 226. The database forming the memory system 226 may be hosted by a third party and accessed by applications forming the components 222, 224, and 228 that are configured to run on the various computing devices forming the example VI system 220.

The example reporting system 228 may also be embodied as one, two, or more computing devices capable of allowing a user to store, read, visualize, hear, or otherwise perceive reports indicative of the remaining life of a particular rope under test as calculated by the example VI system 220. These reports can be any form and can be read or distributed asynchronously, periodically, or according to a predetermined schedule by one or many computing devices over the life of the rope under test.

With the above hardware now configured, shown also is the control system. Here the control system comprises logic and artificial intelligence logic distributed throughout the VI system 220, which logic are subsystems or modules of any one or more of the components of the VI system as appropriate for timely and secure implementation.

More particularly, as part of the control system, the visual data is analyzed using a trainable knowledge base implemented within logic of a control system of the mobile device. The data pipeline is the module of the control system which initially and ongoingly stores the data. Said another way, the data pipeline is a trainable knowledge base of captured, visual data, which first includes the visual data (see FIG. 1) known from prior captures to start the build of the knowledge base. This data pipeline is further elaborated on with reference to FIG. 8 and within the examples below. The data pipeline is then enhanced into trainable knowledge base thereafter by providing it with a large amount of continued, relevant capture data/visual data. In turn, the knowledge base learns the patterns and relationships of the images to continuously and iteratively adjust its outputs. The data pipeline can thus be supplemented with more images, labels, metadata, annotations and other image-associated data. It should be understood that the training of the knowledge base can be performed separately from the actual use of the trained, VI system, and thus can be trained online as a separate module, with the subsequently uploaded and now trained VI system being capable of use remote from the programming, i.e., in the field. In one embodiment, therefore, the VI system is small enough in memory and CPU requirements that it can function on-device in the field without access to the cloud, whereas training or retraining of modules is performed through the use of network or cloud access which may be able to access more processing power, although not limited thereto.

Within the control system, from the data pipeline, next is the model management module. The model management contains: (1) the trainable knowledge base built from the data pipeline; (2) the learning algorithm; and, (3) the parameter development subsystem. The knowledge base can learn and be trained to build and refine the data pipeline using any known deep learning module, e.g., Keras® bundled with TensorFlow® (see example). The invention further contemplates any type of deep learning module after the trained build for the further learning utilized in the report calculations. Parameters in the control system are the settings or values that are used by the learning algorithm to generate an expected life for the rope, calculated as the output, thereby displaying a report on the mobile device indicative of the expected life of the rope. Initial, known parameters here, for example, may include the number of cut strands in a rope which must then be related to rope risk through some correlation. What is then learned might be the more qualitative measurement of the categorization of external or internal abrasion severity which can be empirically correlated to a risk level. These types of both quantitative and qualitative parameters can be learned during the training process, then utilized for learning and generating the expected life. Stand-alone empirical models can be used to correlate observed damage to anticipated rope strength loss for a number of damage modes. In addition, data can be generated and accessed for fatigue, creep and UV damage assessments from databases, local or from third-party vendor(s). In general, empirical correlations can be created and stored through tests and observations. Since U.S. Pub. 2021/0190756 (′756) is incorporated herein by reference, known is one example of the “expected life” calculation, although determined from pre-existing data. Expected life can be a numerical label, other quantifiable label, or a qualitative label, e.g. mild/moderate/severe. In other situations, such values can be averaged. With a variance in damage types, other scales can be utilized. Moreover, expected life does not have to factor in future assumptions, as it can be a snapshot of current condition and thus rope “health” and not rope life remaining precisely. Here, the algorithm is trained on the set of data pipeline input data along with known output values that are tied to these inputs, the known output values having been previously associated based on the image data that had coupled thereto all associated data from, for example, the NDE system. Thus, a parameter of a single fray on a rope captured from the image data would be associated with a certain life expectancy of the rope, thus this parameter being set minimizes the difference between an unknown output and a predicted output. All fixed and learned parameters are continuously stored within the model management module and used to make predictions or decisions based on new visual data being captured, thus determining how the control system will behave.

At the preferred level of validation based on performance measures, monitoring and other feedback, the control system can be packaged and deployed as part of the mobile application which would include all of the aforementioned environments and modules. Any reference to “module” means a subsystem or component of the software or methodology which can be integrated or independent and which performs the set of defined functions or tasks. Being on a mobile device, the inputs and outputs can be generated quickly and from remote locations. In the instant disclosure, using the above-described logic, the one or more mobile devices perform automated operations involved in acquiring and analyzing information from a rope for use in generating and providing feedback as to the condition of the rope, e.g., an expected life of the rope is quantitatively determined. Image and/or video data (in the exemplified embodiment, solely image data for ease of capture) is captured while the mobile device is pointed at and travels around the viewing locations of the rope as the user with the mobile device walks or otherwise moves between multiple viewing locations. As such the rope can remain still or inputs and outputs can be captured along various stages of rope deployment. It will be appreciated that one or more or multiple viewing points can also be captured along sections as the rope is deployed to obtain various observations and assessments along the length of the rope as the mobile device remains somewhat stationary or accompanies the deployment. Some or all of the techniques of capturing the visual data is performed via automated operations of an embodiment of the Visual Inspection (“VI”) system, as discussed above.

Thus, in at least some embodiments, one or more processor-based mobile device computing systems are used to capture and generate information regarding a rope based on recorded visual information (e.g., video, photographic images, etc.). As used herein, a generated “image” refers to any visual representation acquired or captured by the mobile device. The term “acquire” or “capture” as used herein with reference to a rope or rope component may refer to any recording, storage, or logging of media, sensor data, and/or other information related to spatial and/or visual characteristics of the rope or subsets thereof, such as by an image or recording component of the mobile device or by another device that receives information from the recording device.

In operation, a user associated with the mobile device approaches the rope, for instance on a ship, arriving with the mobile device at a first viewing section of the rope. In response to one or more interactions of the user with the control system of the mobile device, the VI application initiates capturing a first image of the rope. Furthermore, in certain scenarios and embodiments, a viewing section may be captured in other manners, including to capture multiple still photographs from different perspectives and angles at the viewing location rather than recording video data at the viewing location. The entire rope can be examined or portions thereof, so “length” means a partial length, i.e., one or more sections of interest or most or all of the length of the rope.

In certain embodiments, the VI application may provide real-time feedback to the user of the mobile device via one or more guidance cues during the capturing, such as to provide guidance for improving or optimizing movement of the mobile device during the capturing process.

In various circumstances and embodiments, the VI application may determine that multiple rotations of the mobile device at a viewing location are desirable to adequately capture information there. Once the desirable images have been captured, the mobile device may continue to be moved with respect to the rope to obtain additional images. In this manner, the VI application may receive greater or lesser quantities of rope image data during travel of the mobile device between viewing locations.

In addition, the VI application may in certain embodiments provide guidance cues and other instructions to a user during movement of the mobile device between viewing locations.

In some embodiments, the application may advantageously be used to manually collect visual data of internal features of rope that would not otherwise be seen. For example, one or more locations along a rope may be manually manipulated to expose yarns normally covered by chafe protection or to expose a rope core about which a plurality of yarns are wrapped. In this manner, the VI application may obtain images and provide feedback in response to visual images that would not be available from purely external images of the rope.

Following the capture of a last image, the VI application receives an indication from the user that capture of the rope is complete. The captured information can be processed locally on-device. Alternatively, the captured information can be transferred for processing to the remote VI system via one or more computer networks (e.g., as initiated by a local VI client application, if any, on the mobile device; as initiated by a user of the mobile device; as initiated by the remote VI system, such as periodically or as is otherwise initiated; etc.). In some embodiments, transmission of data need not occur, and analysis is undertaken onsite. The step of image processing is further elaborated on within the example. In various embodiments, such contact and ensuing information transmission is desirable and may occur and be performed at various times. For example, the VI application may allow the user to schedule the transmission for a specified time, or only as instructed. Such would be desirable when capturing larger amounts of data at a remote location such as on a sea-going vessel. Then upon more proximate return, data is transmitted until a particular network connection is available (e.g., in order to utilize a local Wi-Fi connection for such transmission rather than a cellular network connection, such as to lessen or remove the impact of the transmission on a limited “data plan” of the user), or to delay transmitting until the mobile device is docked or otherwise can use a non-wireless physical connection. Although the VI system can function locally at the remote site, the relationship between the client application mobility and the remote processing system enables scalability and ease of integration (see FIG. 5, for example).

A machine learning model, i.e. a knowledge base, for image analysis of HMPE 12 strand external abrasion was created and found to classify the images with the same accuracy of person-to-person comparisons. The work to generate the knowledge base, test and deploy the VI system is discussed below. In addition, a system to capture images of test rope slings was created to generate rope images as a data pipeline for model training of the knowledge base. Work was performed on the automated visual inspection project by addressing it as three separate sub-efforts.

### Example—VI System Data Pipeline, Image Processing and Training

### Lab Bench Initial Image Capture System 80

The first step towards the overall automated visual inspection effort was the design and installation of a system to take or capture images of ropes prior to break testing to be used for the data pipeline and initial training. The rope-moving system consisted of a stepper motor and gear box mated with a programmable motor controller and several switches. A chain drive can also be utilized. The intent was to capture the full length of the clear rope section of each break test sling, full circumference, and associate those photos with the length marks along the sling and thus with the inspection results. Due to the potentially long lengths involved in some rope returns, the focus was on imaging the test slings, not the original cut sections returned.

A stepper motor would move the rope a small distance, e.g., three inches was selected; a set of pictures would be taken; and the stepper motor would move the rope again. This allowed for a much lower frame per second requirement for the cameras. In an additional cost savings and availability-enhancing measure, the decision was made to use grayscale, not color cameras. Tests with training AI models showed that rendering all of the training images to grayscale either had no effect or potentially improved the model accuracy. This was later proven correct.

Any set of image software platforms can be used to interface between cameras, image collection and stepper motor controller to ensure pictures were taken at the appropriate intervals.

### AI Model Training Image Set Creation

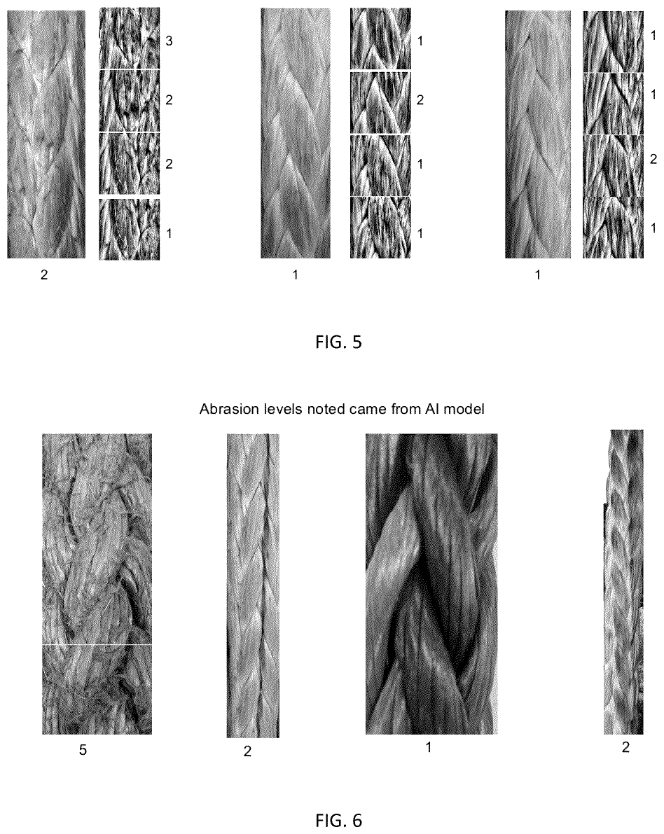

A suitable hand-labeled set of training images within the data pipeline was used to perform deep learning model training. To generate the training image set for this effort, all available RFT images were harvested from their data pipeline repositories and the image segments were manually classified using the 1-7 external abrasion scale, termed herein “damage level scale”, by assessors. “Scale” can be a number, letter or any identifier. In this example it is a number. The damage level scales are averaged along the total strand of image segments (see FIG. 6, for example). “Average” can mean median, mode, arithmetic mean, etc., or anything that can find a measure of central tendency. In general, images/image segments were rated by a single individual then re-reviewed and adjusted to ensure that a consistent image set was available for each abrasion rating/damage level scale. All images were manually cropped 82 to eliminate background, as much as was possible, and oriented 81 to a consistent vertical rope axis to decrease potential training confusion.

The inspection image set was RGB, whereas the lab bench image capture system produces grayscale images. This discrepancy was resolved in training, discussed in the next section, when it became apparent that rendering all images to grayscale improved training accuracy.

### AI Model Training Efforts

This section addresses (1) the final image processing and model training decisions; (2) a list of image pre-processing steps that were tested to determine if they improved the model accuracy, and (3) the model training techniques and decisions made to produce the most accurate inspection app performance.

### Image Pre-Processing

The size of the image to be trained upon was assessed. Image sizes can be an issue. Testing showed that compression of large-pixel images lost some degree of detail from the images, which rendered fine distinctions between abrasion levels harder to spot and therefore less accurate to train upon.

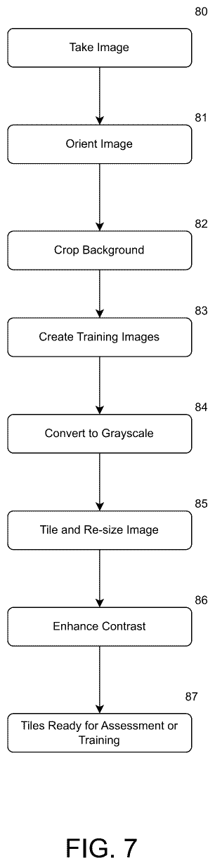

Developed for processing the visual data, therefore, was a tiling module to create the training images 83. The tiling of the image processing step is both used with training and field assessment images, so it is a part of the ongoing build process and use. Therefore, it should be understood that image processing involves a tiling module, which creates training images and assessable, taken images submitted to the model to get a result. Here, instead, for the step of processing the visual data, images were tiled, broken into multiple segments, and the tiled sections submitted for training. See FIGS. 6 and 7 for instance. The best success is achieved when the image was compressed until the width of the image was a pre-determined but still large size, then the image tiled along the length of the rope, but not split along the width. Based on the capabilities, 256×256 pixels was the optimum tile size, rendering the best model accuracy. A subsequent test, when the machine's capabilities were improved, with 512×512 pixels showed no improvement in accuracy.

As has been mentioned previously, the next hurdle addressed was whether RGB or grayscale images created better accuracy in model training. Both were tested and the grayscale images performed better, thus images are converted to grayscale 84. Speculation on the subject pointed towards the diminishment of the effect of coloration changes and focus on the morphological changes of abraded rope.

A decision was made to only test image enhancements that altered the existing tile only. Interpolation or other means to add information to a tile would not be used, although possible. Contrast enhancement or noise reduction methods were explored, for instance, but interpolation to add detail was avoided. Furthermore, only methods that could be conducted using tools found in OpenCV, an open-source image analysis toolbox, were pursued beyond casual investigation.

Noise reduction methods attempted included convolutional matrix filters, simple noise reduction filters, sharpen filters, and similar techniques. Universally, noise reduction failed to show improvements to accuracy. Contrast enhancement, particularly Contrast Limited Adaptive Histogram Equalization (CLAHE), did show a pronounced effect in improving accuracy. The CLAHE algorithm equalizes the contrast histogram (span of darkest spots to lightest spots in the tile). This has the unfortunate effect of making it difficult for the human eye to assess the tile for abrasion level but enhanced the ability of the AI model to train and improved accuracy. Thus, it was necessary for people to review the tiles prior to processing but the AI could only train on processed tiles. As the CLAHE algorithm does have programmable parameters, testing was necessary to select the optimum setting. The final parameters used are noted in the last subsection where the final image processing steps are listed. Accordingly, although not critical, contrast enhancement can be employed to improve clarity and/or increase readable detail and the above is one example with alternative enhancement possibilities available.

When very little of the image enhancement techniques were found to have significant effects on the model accuracy, a critical re-review of the unaltered training image tiles was conducted. It was found that a significant number of images looked like they contained sufficient detail for training but actually lacked, when magnified slightly, that detail. The analogy crafted was that they were images of used ropes similar to impressionistic paintings where the illusion of detail is given but a closer, or higher magnification, look shows that the detail is lacking. All such image tiles were deleted from the training set.

### Image Cropping

As mentioned previously, the historical dataset used for initial training of the machine learning model includes many images with various backgrounds which were found to reduce the accuracy of models. This was resolved manually to create the training set, but solutions were explored using OpenCV and Python to address future situations, including the possible need to crop backgrounds on-device as a pre-processing step in the field. Two methods were assessed to automatically crop and split source images to remove background and provide images of the correct size for training. The invention contemplates that some images may contain some background with little to no effect depending on the size of the data set, but in this current embodiment background is cropped out.

One method relies on using a greyscale threshold method to create a binary image which is made up entirely of black and white pixels. From a binary image, finding the edges of the rope is possible by differentiating a normalized 1D array of the sum of image columns.

### Training Methodology

Using the tiling module, the training work was then conducted, in one embodiment, using a classification style AI model wherein the module comprises generating and assigning a damage level scale to each image segment along the length of the rope. In this style of model, the individual damage level scale classification labels might be 1,2,3, . . . but the model does not necessarily acknowledge that 1 is less than 2 which is less than 3 etc. The interrelationships between the model labels are those defined by the training, not by the name of the label. We did speculate on the use of a model that did actually acknowledge that a level 1 label was less abraded than a level 2 and so on, but limited testing of the concept showed poor results. Anomaly detection was also a speculative approach for binary situations (is the rope a level 6/7 or not, for instance). In this approach one trains on two labels, one the “Good” and the other the anomaly, and the model determines if the tile being checked is “Good” or an anomaly. This approach was also shown to have poor results.

Finally, a model approach was attempted where the tiles were sent for contour detection and then trained upon the contours in the images. Essentially, the more abraded the rope is, the more lines the contour detection filter found and the more curved the lines were. The less abraded the rope was, the contour detection found fewer lines in the tile and the lines tended to be straighter and followed the braid pattern in the rope. This could be thought of as an additional tile preprocessing step being added within the AI model itself.

The classification model has a number of training parameters that address how the training images are used. Random flip, height, rotation and zoom all cover means by which added randomness can be included in the training set to possibly enhance training. Flip, horizontal vs. vertical, randomly flips some of the images. As the images being trained on are generally axially symmetric, this parameter is of less concern so it was always set such that the flip rendered the picture flipped around the rope axis (rope pictured vertically—rope flipped horizontally and vice versa). Random height and random zoom address sizing of the images. Neither had any apparent effect on training, likely due to the fact that the training tiles were only of rope with no other background to show the effect of scale. Random rotation was set to +/−15° to allow for a degree of misalignment of the rope in the image. At that level, model accuracy was improved but increasing or decreasing from that level seemed to decrease accuracy.

Deep learning model training also uses a model optimizer and loss function to handle how the iterative training is conducted. Testing to find the best optimizer, though, is strictly empirical with AdaMax performing best for our images.

The loss function is essentially a way to measure how well, or poorly, the model is performing. A review of recommendations on the use of loss functions suggested that the sparse categorical cross-entropy loss function instead of the other available on the tool, the categorical cross-entropy function, as our images all belong to only a single label. That is, an image would only represent a single abrasion level. The categorical cross-entropy loss function works better when images can fit into more than one label and the sparse function works better when the image can only belong to one.

### Example—Knowledge Base Model Testing, Implementation and Learning

### Final Model Creation and Implementation in App

Using the training image tiles and training methodology discussed, a knowledge base and subsequently trained VI system model was created and assessed against multiple test image sets. Initially, the model was tested against a large number of randomly selected image segments/tiles that had been removed from the training set. This allowed a very clear picture of the model's performance against tiles that were similar to the tiles used to train the model.

Final knowledge base model training and most of the model testing is conducted using Keras® models. In order to create a portable model that can be put into the app for all platforms; iOS®, Android®, and Windows®; the Keras® model was exported into a Tensorflow® model in JavaScript®. The final image processing steps for creating training or assessment images are therefore, and as shown by FIG. 8: (1) take image 80; (2) manually orient image so rope is vertical in picture 81; (3) manually crop out background so only the rope and minimal background is present in image 82; (4) in-app (assessment) or using offline software (creation of training images) 83; (5) convert to grayscale 84; (6) tile and resize image to one or more tiles 256×256 pixel, wherein horizontally, the tile should contain the full width of the rope 85; (7) run the tiles through the contrast enhancement process (“CLAHE”) 86, e.g., CLAHE parameters—row and column height—8 pixels. Clip limit—4; tiles are ready for assessment or training 87.

### Learning Module

As the inspection app is used, external abrasion images are generated, tagged by person or AI, and made available for implementation into the knowledge base, thus the knowledge base is “enhanced”. Similarly, inspection images from the lab bench image collection system can be continually gathered for RFTs processed in the lab to enhance the knowledge base. These images can serve as a data stream of images that can be processed and used for knowledge base model training enhancement.

It should be understood that the above modules are examples and by no means limiting.

The current classification style model can be departed from for external abrasion and other possible means to create models are possible, such as the contour approach. In addition, other models can be employed to address other damage modes or ropes.

Thirdly, it is envisioned that within the UI experience within the app, a “helper” model can be employed that tells whether the user has taken a picture of a rope for assessment or some other non-rope object. In a more advanced version of this, the model or a second model would be able to tell if the rope image is in focus.

From the foregoing it will be appreciated that, although specific embodiments have been described herein for purposes of illustration, various modifications may be made without deviating from the spirit and scope of the invention. Accordingly, the invention is not limited except as by corresponding claims and the elements recited by those claims. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so embodied.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A computer-implemented method for inspecting a rope, comprising the steps of:
using a mobile device, capturing visual data of said rope, wherein said visual data includes one or more sections of said rope along a length thereof;
analyzing said visual data using a knowledge base implemented within logic of a control system of said mobile device,
calculating, from said knowledge base, an expected life for said rope;
generating a report on said mobile device displaying said expected life of said rope as calculated from said knowledge base.

2. The computer-implemented method of claim 1, further comprising the step of processing said visual data to ready said visual data for analysis.

3. The computer-implemented method of claim 2, wherein the step of processing said visual data further comprises the step of tiling said visual data, wherein said visual data is broken into multiple image segments along said section of said rope.

4. The computer-implemented method of claim 3, wherein for the step of tiling said visual data, said visual data is cropped to form each said image segment with minimal background.

5. The computer-implemented method of claim 3, wherein for the step of tiling said visual data, contrast of each said image segment is enhanced.

6. The computer-implemented method of claim 3, further comprising generating and assigning a damage level scale to each said image segment along said length.

7. The computer-implemented method of claim 6, further comprising the step of averaging each said damage level scale.

8. The computer-implemented method of claim 2, further comprising the step of converting said visual data to grayscale.

9. The computer-implemented method of claim 1, further comprising allowing said knowledge base to be continuously supplemented from a data pipeline.

10. The computer-implemented method of claim 1, further comprising allowing said knowledge base to continuously learn to enhance calculations for said expected life.

11. The computer-implemented method of claim 1, wherein for the step of capturing said visual data, said mobile device is moved along said rope while said rope remains stationary.

12. A non-transitory computer-readable medium with stored instructions for inspecting a rope, the instructions when executed by a processor, cause the processor to:
capture visual data of said rope using a mobile device, wherein said visual data includes one or more sections of said rope along a length thereof;
analyze said visual data using a knowledge base implemented within logic of a control system of said mobile device;
calculate, from said knowledge base, an expected life for said rope;
generate a report on said mobile device displaying said expected life of said rope as calculated from said knowledge base.

13. The computer-readable medium of claim 12, further comprising instructions that when executed causes the processor to, after said visual data is captured, process said visual data to ready said visual data for analysis.

14. The computer-readable medium of claim 13, further comprising instructions that when executed causes the processor to tile said visual data, wherein said visual data is broken into multiple image segments along said section of said rope.

15. The computer-readable medium of claim 14, further comprising instructions that when executed causes the processor to crop said data to form each said image segment with minimal background.

16. The computer-readable medium of claim 15, further comprising instructions that when executed causes the processor to enhance contrast of each said image segment.

17. The computer-readable medium of claim 14, further comprising instructions that when executed causes the processor to generate and assign a damage level scale to each said image segment along said length.

18. The computer-readable medium of claim 17, further comprising instructions that when executed causes the processor to average each said damage level scale.

19. The computer-readable medium of claim 12, further comprising instructions that when executed causes the processor to convert said visual data to grayscale.

20. The computer-readable medium of claim 12, further comprising instructions that when executed causes the processor to allow said knowledge base to be continuously supplemented from a data pipeline.

21. The computer-readable medium of claim 12, further comprising instructions that when executed causes the processor to allow said knowledge base to continuously learn to enhance calculations for said expected life.

22. The computer-readable medium of claim 12, further comprising instructions that when executed causes the processor to, for the step of capturing said visual data, capture said visual data while said mobile device is being moved and said rope remains stationary.
